(19) United States
(12) Patent Application Publication
(10) Pub. No.: US 2013/0091246 A1
(43) Pub. Date: Apr. 11, 2013

(54) SYSTEMS AND METHODS FOR ACQUIRING ADDITIONAL INFORMATION REGARDING BROADCAST MEDIA EVENTS

(71) Applicant: Michael William URBANSKI, Annapolis, MD (US)

(72) Inventor: Michael William URBANSKI, Annapolis, MD (US)

(21) Appl. No.: 13/645,710

(22) Filed: Oct. 5, 2012

Related U.S. Application Data
(60) Provisional application No. 61/543,676, filed on Oct. 5, 2011.

(51) Int. Cl. H04L 29/08

(52) U.S. Cl. CPC H04L 67/00
USPC 709/217

(57) ABSTRACT

A system and method are disclosed that provide a safe and convenient mechanism by which users may identify events in broadcast media presentations regarding which the users desire to obtain additional information. Users are provided with an ability to identify an event or occurrence in a broadcast media presentation provided by a service provider. Service providers are provided with a mechanism to respond to user requests for additional information by providing, to a requesting user, a targeted communication, in a form of, for example, an email, a text message, or an other electronic data format, the targeted communication being responsive to the user's request and specifically addressed to the user. The user is provided with a “one button” transmitting capability on a communication device as an event marker to mark, for the service provider, the event or occurrence in the broadcast media presentation that is of interest to the user.

This application claims priority to U.S. Provisional Patent Application No. 61/543,676, entitled “System and Method for Providing Information Related to Radio Information,” filed Oct. 5, 2011, the disclosure of which is hereby incorporated by reference herein in its entirety.

### BACKGROUND

1. Field of the Disclosed Embodiments

This disclosure relates to systems and methods that may provide a safe and convenient mechanism by which users may simply identify events in broadcast media presentations regarding which the users desire to obtain additional information and a mechanism for delivery of the additional information to the users.

2. Related Art

In the last two decades, there has emerged an increasingly widespread proliferation of alternative delivery techniques for providing broadcast media to individual users via means that are traceable back to the individual users. These traceable means include myriad contract services provided by one or more of cable television service providers, direct broadcast satellite television service providers, Internet service and content providers, cellular telephone network service providers, satellite radio service providers and the like (which will be broadly and collectively referred to in this disclosure as “wireless communication and entertainment service providers”). Common to these means are that the services are generally provided to the individual users according to some form of contractual agreement that likely includes a fee. As a result, the service providers may be provided varying levels of contact, location, content preference and other information for the individual users.

Individual users may provide email addresses to service providers that are not directly associated with the provision of their Internet content, cellular telephone numbers to service providers that are not associated with providing communications connectivity services to their mobile devices, and social media contact information to virtually everyone. This intermingling and comingling of direct contact information regarding individual users of contract broadcast media services in their various forms provides significant advantages to the service providers. The service providers are assured a reasonably high level of confidence with regard to their ability to contact the users and to get paid for their service. The service providers also have databases of information that they may be able to use to their advantage in cooperating with other product and service providers in assisting those individuals and companies in focusing their marketing and advertising efforts according to discernible demographics.

These capabilities are further enhanced when one considers that many of the communication devices with which the service providers exchange information, whether semi-fixed, or completely mobile, are often programmed to provide the service providers and others with some indication as to a geographic location of the communication devices in use. Demographic indicators regarding use, content preferences and characteristics of a user population can be additionally catalogued according to geographic locations based on available, collectable information.

### SUMMARY OF EMBODIMENTS

It would be advantageous to exploit the capabilities of communicating devices to the benefit of the user population by providing users with a simple mechanism by which to balance the advantages of service providers having access to information on the users, including contact, demographic, preference, profiling and location information for specific users or groups of users at any particular time.

Exemplary embodiments of the disclosed systems and methods may provide users with an ability, via one or more communicating devices, to identify an event or occurrence in a broadcast media presentation provided by a service provider about which the user would like to be provided additional information.

Exemplary embodiments may provide service providers with a mechanism to respond to user requests for additional information by providing, to a requesting user, a targeted communication, in a form of, for example, an email, a text message, or an other electronic data format, the targeted communication being responsive to a user's request for additional information regarding a specific even or occurrence in a broadcast media presentation.

Exemplary embodiments may afford a user an opportunity to, for example, gain benefit from a broadcast advertisement without interrupting a flow of what the user is doing. In exemplary embodiments, a user operating a vehicle, for example, may hear an advertisement on the vehicle radio that includes a contact telephone number, URL, email address or other like detail. In such a situation, it is generally impractical and may be dangerous for the user to attempt to capture the contact information by writing it down, entering the number into his or her cellular telephone or by executing some other equally challenging or precarious undertaking while continuing to operate the vehicle. According to the disclosed schemes, the user may be provided some form of “one button” transmitting capability on the vehicle radio augmented with an additional information request processor, or on another communicating device operating cooperatively with the vehicle radio, to mark, for the service provider the event or occurrence in the broadcast media that is of interest to the user, in this case an advertisement, and on which the user desires to acquire additional information.

Exemplary embodiments may provide a safer manner by which, in certain situations, a user may be provided desired additional information related to a broadcast media event or occurrence that the user is able to exploit available technology to identify.

Exemplary embodiments may allow a user to benefit from non-interruptive advertising in a manner that also benefits those around the user as well as the advertising industry.

Exemplary embodiments may provide to the service provider information on a real-time location of a communicating device to aid the service provider in formatting the content of the targeted communication with the additional information provided to be provided to the user.

Exemplary embodiments may provide a user watching a television broadcast to identify a commercial advertisement offering a particular discount on a good or service that is of interest to the user by activating an “info” or otherwise identified button on a programmed wireless communication device such as, for example, a smartphone, an iPhone®, an iPad®, an Internet connected tablet or laptop, or the like that may be electronically connected to, or otherwise in communication with the television. The service provider's cued response may be to email a coupon for the commercial advertisement offering to the user's email account of record such that the coupon is then accessible from the programmed wireless communication device. The coupon may later be accessed for display on, or printing from, the wireless communication device. Later during the same television broadcast, the method may be repeated by the same or another user to obtain additional information regarding other advertising, occurrences, events or presentations.

Exemplary embodiments may allow advertisers to determine which advertisements create the greatest response in a particular geographic location and/or in real time. Service providers may be able to charge advertisers on a measurable per action basis, potentially increasing revenue per advertisement for the service provider while the advertiser saves money overall because the advertiser is only paying for responsive action.

Exemplary embodiments may provide a mechanism to exploit in place technical and information exchange capabilities to the benefit and safety of individual users. Exemplary embodiments may make use of a full scope of broadcast media receiving and information exchange devices to carry into effect the disclosed schemes for providing a user additional information that is particularly requested from a broadcast audio and/or video program, commercial or message.

In exemplary embodiments, the means by which information is exchanged may be a personal digital assistant (PDA), smart phone or other like portable device; an Internet web browser or website; a cellular telephone or other wireless communication device; a television or web-based television device; an Internet enabled device or appliance; an electronic and/or wireless health monitoring device; a kiosk displaying or presenting information either via audible or visual means; any of a myriad of radio or other audio broadcast reception devices; or combinations of these.

Exemplary embodiments may use a Global Positioning System (GPS) receiver, which is common on most wireless devices, such as smartphones and tablets, and wireless WiFi receivers on a user's local wireless device to passively geo-locate the user's local wireless device.

These and other features, and advantages, of the disclosed systems and methods are described in, or apparent from, the following detailed description of various exemplary embodiments.

### BRIEF DESCRIPTION OF DRAWINGS

Various exemplary embodiments of the disclosed systems and methods for providing a safe and convenient mechanism by which users may simply identify events in broadcast media presentations regarding which the users desire to obtain additional information and a mechanism for delivery of that additional information to the users will be described, in detail, with reference to the following drawings, in which:

FIG. 1 illustrates a schematic diagram of an exemplary overview of a networked communication environment within which the systems and methods according to this disclosure may operate;

FIG. 2 illustrates a block diagram of an exemplary system that provides a mechanism by which users may simply and safely identify events in broadcast media presentations regarding which the users desire to obtain additional information and a mechanism for delivery of that additional information to the users according to this disclosure; and

FIG. 3 illustrates a flowchart of an exemplary method by which users may simply and safely identify events in broadcast media presentations regarding which the users desire to obtain additional information and receive delivery of that additional information according to this disclosure.

### DETAILED DESCRIPTION OF EMBODIMENTS

The systems and methods for providing a safe and convenient mechanism by which users may simply identify events in broadcast media presentations regarding which the users desire to obtain additional information and a mechanism for delivery of that additional information to the users according to this disclosure will generally refer to this specific utility for those systems and methods. Exemplary embodiments described and depicted in this disclosure should not be interpreted as being specifically limited to any particular communication network configuration, any particular broadcast media receiving device, or any particular wireless communicating device, or as being directed to any particular intended use. In fact, any information exchange capability that may facilitate simple identification to a service provider of a broadcast media event or occurrence about which a user may desire to have additional information, and any information exchange capability by which the service provider may then match contact information for the requesting user, investigate the broadcast media event, and format and forward a targeted message in response to the information request that may benefit from the systems and methods according to this disclosure is contemplated.

Specific reference to, for example, any particular wireless device should be understood as being exemplary only, and not limited, in any manner, to any particular class of devices. The systems and methods according to this disclosure will be described as being particularly adaptable to being hosted on commercially-available hand-held wireless devices such as smartphones, tablets, PDAs and the like, but should not be considered as being limited to only these classes and types of devices. Further, specific reference to any particular broadcast media receiving device, such as a television or radio, should be interpreted as broadly including any device by which broadcast, satellite and/or targeted audio and/or video content may be received by a user.

Individual features and advantages of the disclosed systems and methods will be set forth in the description that follows, and will be, in part, obvious from the description, or may be learned by practice of the features described in this disclosure. The features and advantages of the systems and methods according to this disclosure may be realized and obtained by means of the individual elements and combinations of those elements as particularly pointed out in the appended claims. While specific implementations are discussed, it should be understood that this is done for illustration purposes only. A person skilled in the relevant art will recognize that other components and configurations may be used without departing from the spirit and scope of the subject matter of this disclosure.

Various aspects of the disclosed embodiments relate to a system and a method for providing a safe and convenient mechanism by which users may simply identify events in broadcast media presentations regarding which the users desire to obtain additional information and a mechanism for delivery of that additional information to the users. The disclosed scheme allows users to obtain the benefit from, for example, an advertisement, event or occurrence of other specific information presented in broadcast media content on terms that are convenient, and safe, for the user by not interrupting what the user is otherwise doing.

A first specific example of the utility of the disclosed schemes involves a user as the operator of a vehicle. The user may hear an advertisement on the vehicle radio while operating the vehicle in a circumstance where the user cannot safely respond immediately to the advertisement by, for example, memorializing a presented contact telephone number, URL or email address in any form, even if the user truly desires the product or service. According to the disclosed schemes, the user may be provided a “one button” capability via the vehicle radio, or via a cooperating device in communication with the vehicle radio, to identify the advertisement to a service provider as an event or occurrence in the broadcast media presentation on which the user wants additional information. The service provider may then search a database for additional information associated with the advertisement and contact information for the requesting user. The service provider may format a directed message to be delivered to the requesting user as, for example, an email, a text message or other electronic delivery format. This scheme of non-interruptive advertising may provide benefits not only to the individual users but also to advertisers and service providers.

The above example makes clear the safety benefits to the individual user and to the general populace when the user, as a vehicle operator, is not distracted by trying to collect information in real time regarding some broadcast media presentation content that is of interest to the user. It should be easily recognized that the system for communicating via a vehicle radio is especially troublesome. A vehicle operator may become preoccupied in trying to remember, write down, or otherwise record a contact telephone number, URL or email address of the advertiser to later access further desired information. This is being asked of the vehicle operator in motion and is believed to be unsafe for not only the vehicle operator, but of the other vehicles, operators and passengers on the road in the vicinity of the vehicle operated by the user. The safety of the public may be, in some measure, put at risk with every advertisement and public service announcement that is communicated via traditional radio broadcasting and/or a satellite radio system in a vehicle. Addressing this safety risk is an objective of the disclosed schemes and a motivation to implement a better system according to the disclosed schemes.

A second specific example of the utility of the disclosed schemes involves a user in a group watching television programming. A commercial advertisement may be presented that offers a discount coupon for a particular good, product or service. A user interested in the particular good, product or service may non-interruptively select an “info” button on a mobile communication device such as, for example, an iPhone® that is electronically connected to, and or in communication with the television on which the programming is presented. The advertiser's coupon may be emailed to the mobile communication device while the television programming continues uninterrupted. The advertiser's coupon may later be accessed, printed, displayed and/or used by the user when contracting for the particular good, product or service. Later in the television programming, another commercial advertisement may be presented that is of interest to the same or another user who, in turn, may separately select the “info” button to repeat the information exchange and augmentation process. Separate promotional information regarding this commercial advertisement may be emailed to the user.

The disclosed scheme may provide a benefit to an advertiser by which the advertiser may determine which advertisements create the greatest response according to an individual demographic at a particular time and in a particular location. The service provider may set revenue rates on a per action basis and make more money per advertisement while the advertiser saves money because the advertiser is only paying for individual actions.

The disclosed scheme may be implemented using virtually any communicating device including a communicating device that may be used as a remote control device. The disclosed scheme may be embodied in an application by which a smartphone is programmed, or via a voice recognition and activation program that is recognizable by the electronic communicating device. Any of these methods may be employed by a user to identify the content of the broadcast media presentation on which the user is interested in obtaining additional information.

The disclosed embodiments may be advantageously operated in a networked communication environment. In this regard, a user's wireless communication device may be operated cooperatively with a broadcast media receiving device such as, for example, a television or radio in the networked communication environment, to provide information to and receive information from a broadcast media content or service provider.

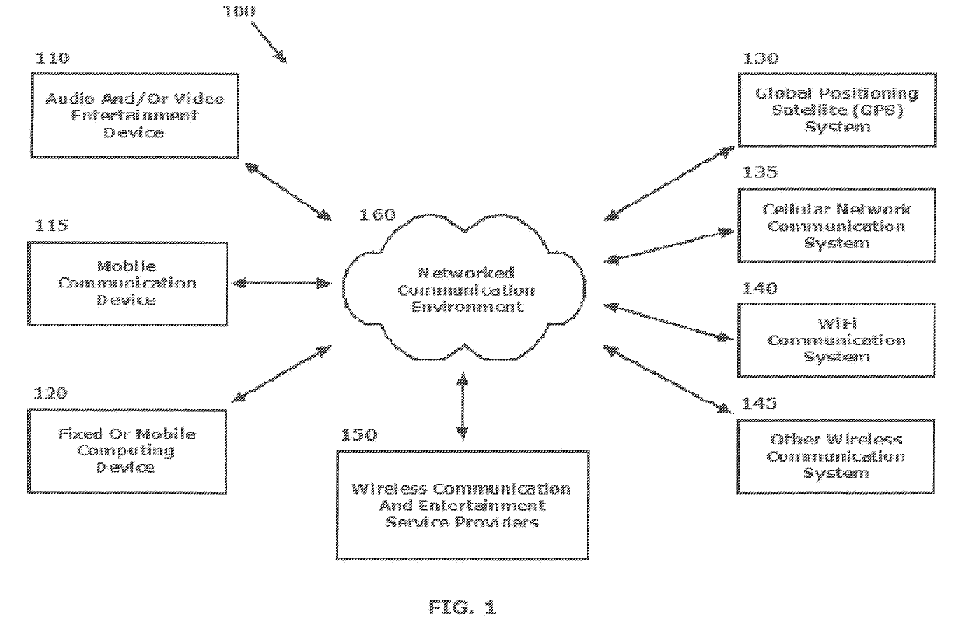

FIG. 1 illustrates a schematic diagram of an exemplary overview 100 of a networked communication environment 140 within which the systems and methods according to this disclosure may operate. As shown in FIG. 1, one or more of an audio and/or video entertainment device 110 (such as, for example, a radio and/or television), a mobile communication device 115 and a fixed or mobile computing device 120 may operate cooperatively to provide information to and/or receive information from one or more wireless communication and entertainment service providers 150. The communications may be direct, or may be via one or more communication systems as facilitators of the communications including, but not limited to a cellular network communication system 135, a WiFi communication system 140, including multiple wireless access points, or an other wireless communication system 145.

For mobile communication devices 115, a position of the mobile communication devices 115, as well as for mobile computing devices 120, may be provided with reference to one or more of a global positioning satellite (GPS) system 130, a localization capacity of the cellular network communication system 135 and/or the WiFi communication system 140, individually or in combination.

A wireless communication and/or entertainment service provider 150 may provide broadcast content to one or more audio and/or video entertainment devices 110. A user watching the video content and/or listening to the audio content may determine that the user wants additional information regarding some broadcast event, occurrence or content, which may include, but not be limited to, a commercial (advertisement, program, music, public service announcement or other content) being played or displayed on a particular one of the one or more audio and/or video entertainment devices 110. The user may activate a single “info,” “more,” “data,” or similarly-marked button, on the one or more audio and/or video entertainment devices 110, or a mobile communication device 115 in cooperative communication with the one or more audio and/or video entertainment devices 110 that may be usable in communicating user identification of the broadcast event, occurrence or content to the one of the one or more wireless communication and entertainment service providers 150 responsible for providing the broadcast content, or with which the user is in a contractual relationship. The one of the one or more wireless communication and entertainment service providers 150 with which the user communicates may recover the additional information related to the user-identified broadcast event, occurrence or content. The one of the one or more wireless communication and entertainment service providers 150 with which the user communicates may further recover the contact information for the user making the request. Either or both of these pieces of information content may be recovered from a local database administered by the service provider, or may require that the service provider obtain further information from other sources including a broadcast content provider that provides broadcast content via the service provider to individual users. With the collected information, the service provider may format an email, a text message or other electronic communication to convey the additional information on the user-identified broadcast event, occurrence or content to the user using the stored contact information for the user.

The user may interface directly with a radio or a television, or other content delivery device, to send a request for information that may include the time of the request and the location of the content delivery device or the requesting device to the wireless communication and/or entertainment service provider 150.

In embodiments, the wireless communication and/or entertainment service provider 150 may be provided with an application programming interface (API) that enables the wireless communication and/or entertainment service provider 150 to request from participating content providers, such as radio stations, information about what commercials were played on what radio stations and when, and any information that the radio station would like to have associated with the response to the request for information. The wireless communication and/or entertainment service provider 150 may then add any information that the wireless communication and/or entertainment service provider 150 wishes to the response before sending the information to the user in response to the user's request. For example, the wireless communication and/or entertainment service provider 150 may include additional information that is deemed relevant or helpful to the user such that the user may be given information, for example, on other goods, products or services that may be tied to the additional information for the user-identified content.

The wireless communication and/or entertainment service provider 150 may in addition compile statistics on the type of broadcast media content for which information was requested and any corresponding demographic information. This information may be used to determine how successful an advertising campaign may be in real time. This may provide revenue which allows the wireless communication and/or entertainment service provider 150 to reduce or eliminate costs for the users. In addition, the wireless communication and/or entertainment service provider 150 may charge a fee to content providers or related advertisers for each time that a user requests information about a content, event, or occurrence, including, for example a public service announcement or a commercial.

The wireless communication and/or entertainment service provider 150 may receive information from content providers without having to directly request the information in response to a request from a user. Content providers, such as radio and television stations, may periodically, occasionally or near-continuously send to the various wireless communication and/or entertainment service providers 150 information that identifies the content provider, for example, by frequency and/or location, broadcast times for specific events including advertisements and the additional information to be supplied to a user. For example, radio stations could send to the wireless communication and/or entertainment service provider 150 formatted data with the necessary information for each commercial played in a given time window. By storing the data locally in a database, the wireless communication and/or entertainment service provider 150 would not have to request information about the same commercial played by a radio station more than once.

As indicated, the communicating components need not be implemented as single units. Instead, a traditional radio as an example of an audio and/or video entertainment device 110 may be coupled with a separate mobile communication device 115 that includes a request processor including at least a processor, a data storage device, an external communication interface and a user interface (e.g., a button, remote control, voice activated interface or other user interface control) for indicating that additional information about a broadcast media content is desired. The request processor may include a microphone for receiving at least a portion of an audio signal corresponding to the commercial for which the user wants additional information. The request processor may record the portion of the audio signal and send it along with the request for more information. By correlating the time at which the commercial was played (potentially with geographic information for one or more of the audio and/or video entertainment device 110), the mobile communication device 115 and the fixed or mobile computing device 120), the wireless communication and/or entertainment service provider 150 may determine which radio station the user was listening to and provide information corresponding to the commercial for which more information is being requested. By using the time of the commercial and the geographic information sent with the request, the wireless communication and/or entertainment service provider 150 may reduce the number of commercial segments that need to be compared with the recorded audio clip in order to determine to which station the audio clip corresponds.

The audio signals may contain embedded watermarks, and the information in the embedded watermarks may be extracted and sent instead of sending the audio signals themselves. This may reduce communication requirements but may increase processing requirements.

In embodiments, the wireless communication and/or entertainment service provider 150 may be bypassed if sufficient information is embedded into the audio signal itself. Instead, the communication interface may simply directly send to the user (at a registered address) the information about the commercial that was decoded from the embedded information. In such a configuration, an enhanced radio would need to be capable of being programmed with the desired address. Such programming could be performed using the communication interface over a WiFi connection (or other connection) to the enhanced radio using a web browser or similar configuration application. In such a configuration, the information could also be stored locally in the enhanced radio until the radio returned to a home network where the user could query the information directly from the enhanced radio over a WiFi connection, for example. In such configurations, where the wireless communication and/or entertainment service provider 150 is not needed, the enhanced radio would include a web server (or similar application) that controls sending information to and receiving information from the enhanced radio.

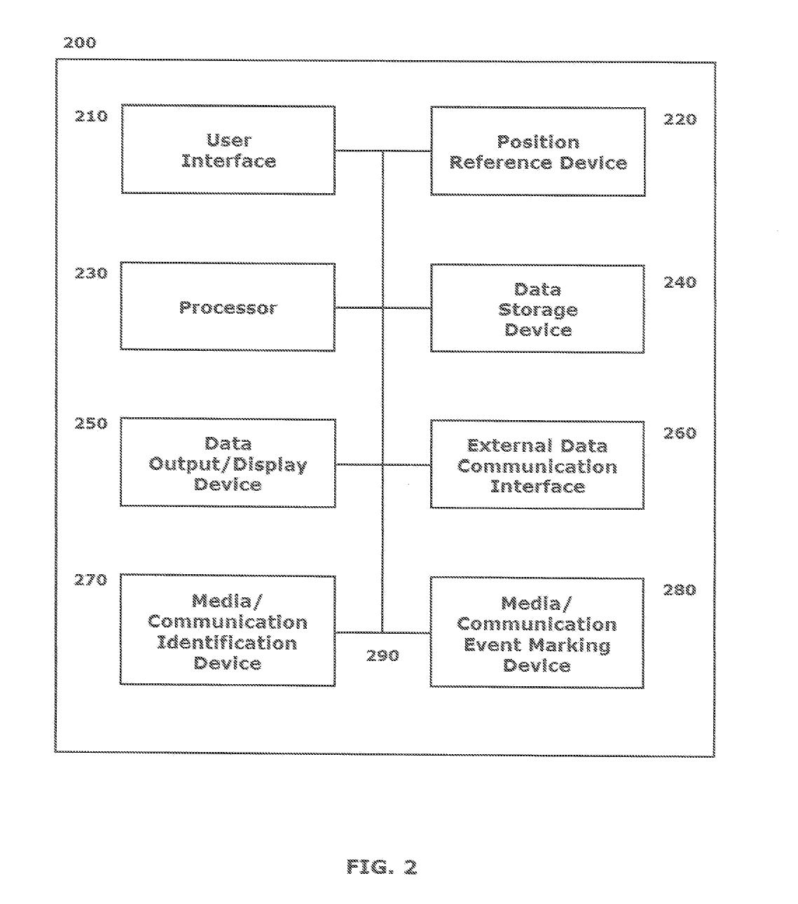

FIG. 2 illustrates a block diagram of an exemplary system 200 that provides a mechanism by which users may simply and safely identify events in broadcast media presentations regarding which the users desire to obtain additional information and a mechanism for delivery of that additional information to the users according to this disclosure. The exemplary system 200 shown in FIG. 2 may be embodied in, for example, one or more of an audio and/or video entertainment device 110 (such as, for example, a radio and/or television), a mobile communication device 115 and a fixed or mobile computing device 120, as shown in FIG. 1, may operate cooperatively to provide information to and/or receive information from one or more wireless communication and entertainment service providers 150 according to the disclosed schemes.

The exemplary system 200 may include a user interface 210 by which the user may communicate with the exemplary system 200. The user interface 210 may be configured as one or more conventional mechanisms that permit a user to input information to the exemplary system 200. The user interface 210 may include, for example, an integral or attached keyboard and/or mouse by which a user may enter data into the exemplary system 200. The user interface 210 may alternatively include (1) a touchscreen with “soft” buttons, or for use with a compatible stylus; (2) a microphone by which a user may provide oral commands to the exemplary system 200 to be “translated” by a voice recognition program or otherwise; or (3) other like devices for user operation of, and data exchange with, the exemplary system 200. The user interface 210 may be integrated into a graphical user interface (GUI) associated with one or more of the audio and/or video entertainment device 110 (such as, for example, a radio and/or television), the mobile communication device 115 and the fixed or mobile computing device 120 as shown in FIG. 1. The user interface 210 may include a single button, appropriately labeled, that may be usable to specify a broadcast media event, occurrence or content that a user may desire to “mark” in a manner that specifies to a broadcast service provider that the user desires to obtain additional information regarding the “marked” event, occurrence or content.

The exemplary system 200 may include one or more position reference devices 220 for localizing a position of the exemplary system 200. Such position reference device(s) 230 may comprise a GPS receiver for receiving global positioning satellite location information to the exemplary system 200, and/or other like device that may localize a position of the exemplary system 200 for use.

The exemplary system 200 may also include one or more local processors 230 for individually operating the exemplary system 200 and carrying out processing and control functions associated with the disclosed schemes. Processor(s) 230 may include at least one conventional processor or microprocessor that interprets and executes instructions to execute communications and make the determinations according to the methods of this disclosure.

The exemplary system 200 may include one or more data storage devices 240. Such data storage devices 240 may be used to store data or operating programs to be used by the exemplary system 200, and specifically the processor 230. Data storage device(s) 240 may include a random access memory (RAM) or another type of dynamic storage device that stores information and instructions for execution by processor(s) 230. Data storage device(s) 240 may also include a read-only memory (ROM), which may include a conventional ROM device or another type of static storage device that stores static information and instructions for processor(s) 230. Further, the data storage devices 240 may be integral to the exemplary system 200, or may be provided external to, and in wired or wireless communication with, the exemplary system 200.

The exemplary system 200 may include at least one data output/display device 250 which may be configured as one or more conventional mechanisms that output information to the user, including a display or one or more speakers for alerting a user to additional information received by the exemplary system regarding the a broadcast event or occurrence of interest as identified by a user. The data output/display device may separately be an output port for connection to a printer, a copier, a scanner, a multi-function device, or a remote storage medium, such as a memory in the form, for example, of a magnetic or optical disk with a corresponding disk drive, to which the additional information may be output or stored for later use according to known techniques.

The exemplary system 200 may include one or more external data communication interfaces 260 by which the exemplary system 200 may communicate with components external to the exemplary system 200 including other communication devices with which the exemplary system 200 may be in wired or wireless communication. External data communication interface(s) 260 may include any mechanism that facilitates direct communication, or communication via a network environment, for identifying one or more broadcast media events or occurrences to at least one of a broadcast media service or content provider as indicated by a user via, for example, a user interface 210 and/or for receiving additional information regarding the one or more identified broadcast media events or occurrences in a communication directed to the identifying user to be stored in the data storage device 240 and/or displayed on the data output/display device in a manner that is usable by the identifying user.

One of the external data communication interfaces 260 may be configured as a communication node that is compatible with one or more of the communication systems identified in FIG. 1 as including the GPS system 130, the cellular network communication system 135, the WiFi communication system 140 and the other wireless communication system 145.

The exemplary system 200 may include a media/communication device 270 that usable to identify individual broadcast media events and occurrence and to determine whether there is additional information available from any source with which the exemplary system 200 is in communication that may satisfy a request from a user regarding a manually-identified broadcast media event or occurrence.

A separate media/communication event marking device 280 may interpret the user manual input and format a request message including identification of the broadcast media event or occurrence of interest, identification of the user or of the communication device transmitting the request, location information for one of the broadcast media receiving device the broadcast the broadcast media event or occurrence of interest, and/or a time of the request.

All of the various components of the exemplary system 200, as depicted in FIG. 2, may be connected by one or more data/control busses 290. These data/control busses 290 may provide wired or wireless communication between the various components of the exemplary system 200, whether all of those components are housed integrally in, or are otherwise external and connected to, an integral communication unit. For example, portions or all of the exemplary system 200 as individual elements or functions may be resident in one or more of an audio and/or video entertainment devices 110 (such as, for example, an enhanced radio and/or an enhanced television).

It should be appreciated that, although depicted in FIG. 2 as an integral unit, the various disclosed elements of the exemplary system 200 may be arranged in any combination of sub-systems as individual components or combinations of components, integral to a single unit, or external to, and in wired or wireless communication with the single unit of the exemplary system 200. In other words, no specific configuration as an integral unit or as a support unit in communication with other units or devices is to be implied by the depiction in FIG. 2.

It should also be appreciated that the system storage and processing functions described above, given the proper inputs, may be carried out in system hardware circuits, software modules or instructions or firmware, or in varying combinations of these.

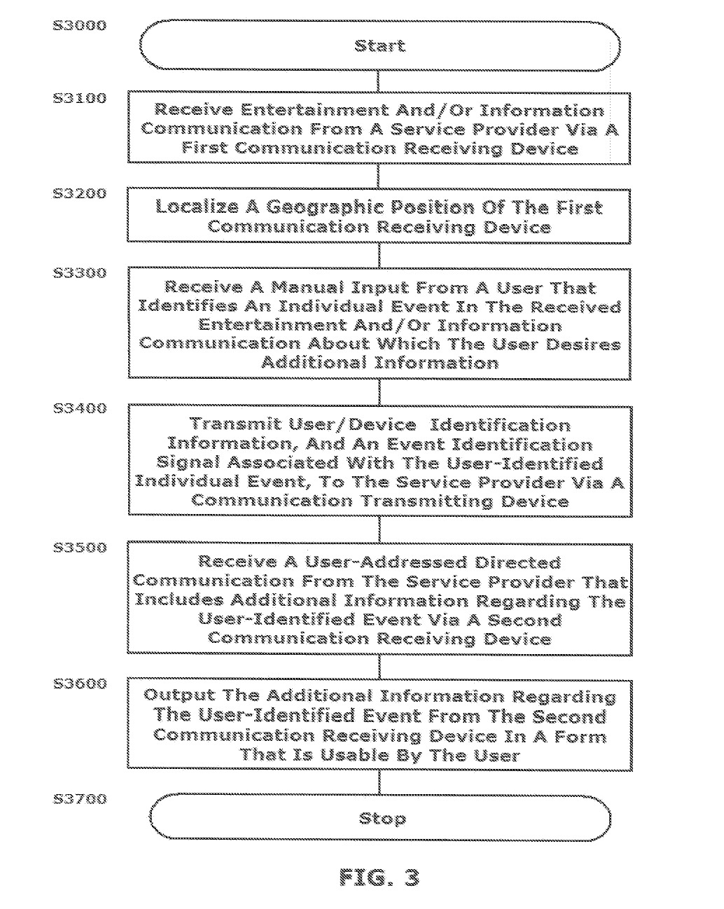

The disclosed embodiments may include a method for providing a safe and convenient mechanism by which users may simply identify events in broadcast media presentations regarding which the users desire to obtain additional information and a mechanism for delivery of that additional information to the users. FIG. 3 illustrates a flowchart of such an exemplary method. As shown in FIG. 3, operation of the method commences at Step S3000 and proceeds to Step S3100.

In Step S3100, entertainment and/or information communication may be received via a first communication receiving device from a service or content provider. The first communication receiving device may be any mechanism by which a broadcast media presentation may be received including, for example a radio or television. Operation of the method proceeds to Step S3200.

In Step S3200, a position or geographic location of the first communication receiving device may be localized on a continuous or discrete basis. Operation of the method proceeds to Step S3300.

In Step S3300, a manual input may be received from a user regarding a specific individual event, occurrence or instance of content in the received broadcast media presentation. The manual input may be employed by the user to identify a specific individual event, occurrence or instance of content in the received broadcast media presentation about which the user desires to acquire additional information. The manual input may include a processed input to identify the specific individual event, occurrence or instance of content in the received broadcast media presentation based on user activation of a single button as an event marker, the single button being associated with a device that receives and presents the entertainment and/or information communication to the user, or a separate communicating device in cooperative communication with the receiving device to carry out the event identifying function. Operation of the method proceeds to Step S3400.

In Step S3400, a formatted message may be sent to a service provider in response to the manual “single button” user input. The formatted message may include identification of the specific individual event, occurrence or instance of content in the received broadcast media presentation that is of interest to the user, identification of the user or of the communication device transmitting the request, location information for one of the user, the broadcast media receiving device or the separate communicating device, and/or a time of the request. Operation of the method proceeds to Step S3500.

In Step S3500, the broadcast media receiving device or the separate communicating device may receive a user addressed directed communication for the service provider that includes any additional information on the identified specific individual event, occurrence or instance of content in the received broadcast media presentation. It should be noted that the device that receives the directed communication may be the broadcast media receiving device, the separate communication device, or an other communication device under the control of the user. Multiple communication paths between multiple devices operated by the user may be employed to undertake the separate communication functions according to the disclosed schemes. The additional information may be information that the service provider has or otherwise information that the service provider may research. The service provider is able to specifically address the directed communication to the user based on information that the service provider holds identifying direct communication paths to the user which may include at least one of a cellular telephone number, an email address, social media contact information and the like. The service provider may update a database of user information based on the information transaction with the user to supplement a database with information on user demographics and user content preferences, for example. Operation of the method proceeds to Step S3600.

In Step 3600, the received additional information regarding the user identified event may be output from the receiving device or displayed on a display screen associated with the receiving device in a manner that is usable by the user. Otherwise, the received additional information may be automatically stored in a data storage component associated with the receiving device for later access by the user. Operation of the method proceeds to Step S3700 where operation of the method ceases.

The disclosed embodiments may include a non-transitory computer-readable medium storing instructions which, when executed by a processor, may cause the processor to execute the steps of the method described above.

Overall benefits of the disclosed embodiments may include simple, practical and safe mechanisms by which a user is only very limitedly distracted or diverted from a primary function while attempting to recover additional information regarding a broadcast media event or occurrence.

The above-described exemplary systems and methods referenced certain conventional components to provide a brief, general description of a suitable communication and processing environment in which the subject matter of this disclosure may be implemented for familiarity and ease of understanding. Although not required, embodiments of the disclosure may be provided, at least in part, in a form of hardware circuits, firmware or software computer-executable instructions to carry out the specific functions described, such as program modules, being executed by a processor. Generally, program modules include routine programs, objects, components, data structures, and the like that perform particular tasks or implement particular data types.

Those skilled in the art will appreciate that other embodiments of the disclosed schemes and techniques may be practiced in communication network environments with many types of communication equipment and supporting computer system configurations, including personal computers, hand-held devices, multi-processor systems, microprocessor-based or programmable consumer electronics, and the like.

Embodiments may also be practiced in distributed communication and computing environments where tasks are performed by local and remote processing devices that are linked to each other by hardwired links, wireless links, or a combination of both through a communication network. In a distributed communication and computing environment, program modules may be located in both local and remote memory storage devices.

Embodiments within the scope of this disclosure may also include non-transitory computer-readable media having stored computer-executable instructions or data structures that may be accessed, read and executed by the user's local wireless communication device using a compatible wired or wireless data reader. Such computer-readable media may be any available media that may be accessed by a processor, general purpose or special purpose computer in, or in communication with, the user's local wireless communication device. By way of example, and not limitation, such computer-readable media may comprise RAM, ROM, EEPROM, CD-ROM, flash drives, data memory cards or other analog or digital data storage device that may be used to carry or store desired program elements or steps in the form of accessible computer-executable instructions or data structures. When information is transferred or provided over a network or another communications connection, whether wired, wireless, or in some combination of the two, the receiving processor properly views the connection as a computer-readable medium. Thus, any such connection is properly termed a computer-readable medium. Combinations of the above should also be included within the scope of the computer-readable media for the purposes of this disclosure.

Computer-executable instructions include, for example, non-transitory instructions and data that may be executed and accessed respectively to cause any of the described communication devices, or processor associated with such devices, to perform certain of the above-specified functions, individually, or in combination. Computer-executable instructions also include program modules that are remotely stored for access by the described communication devices to be executed by processors the processors in the described communication devices when the devices are caused to communicate in a network environment. The exemplary depicted sequence of executable instructions or associated data structures represents one example of a corresponding sequence of acts for implementing the functions described in the steps.

Although the above description may contain specific details, they should not be construed as limiting the claims in any way. Other configurations of the described embodiments of the disclosed systems and methods are part of the scope of this disclosure. For example, the principles of the disclosure may be applied to each individual user where each user may individually deploy such a system or method to identify specific events or occurrences in broadcast media presentations and to receive additional information regarding the identified specific events or occurrences. This enables each user to use the benefits of the disclosure even if any one of the large number of possible applications do not need a specific aspect of the functionality described and depicted in this disclosure. In other words, there may be multiple instances of the describe components each processing information content in various possible ways. It does not necessarily need to be one system used by all end users. Accordingly, the appended claims and their legal equivalents should only define the disclosure, rather than any specific examples given.

We claim:

1. A method for obtaining information regarding media content, comprising:
receiving media content with a receiving device;
providing an input from a user, via a processor in a first communicating device, that specifies a portion of the media content about which the user seeks to obtain information;
receiving a directed communication via a processor in a second communicating device that includes information related to the specified portion of the media content; and
outputting contents of the directed communication from the second communicating device to the user.

2. The method of claim 1, the receiving device being one of a radio or television.

3. The method of claim 1, the input from the user being provided by the user via a single actuation of a process activation device on a user interface for the first communicating device, and the first communicating device being an integral component of the receiving device.

4. The method of claim 1, the input from the user being provided by the user via a single actuation of a process activation device on a user interface for the first communicating device, and the first communicating device being a separate communicating device from the receiving device in cooperative communication with the receiving device.

5. The method of claim 1, the input from the user being supplemented with user identification information and communicated via the processor in the first communicating device to a media content service provider.

6. The method of claim 5, the media content service provider obtaining the information related to the specified portion of the media content from multiple sources and addressing the directed communication to the second communicating device using contact information provided by the user.

7. The method of claim 6, the user regularly using the services of the media content service provider and the media content service provider obtaining the at least one of contact or address information for the user by referencing stored information related to the user's regular use of the media content service provider's services.

8. The method of claim 1, the first and second communicating devices constituting a single communicating device.

9. The method of claim 1, media content comprising at least one of a commercial advertisement, a program, music, or a public service announcement.

10. The method of claim 1, the specified portion of the media content about which the user seeks to obtain information being an input from a commercial advertiser, and the information related to the specified portion of the media content being at least one of contact information for the commercial advertiser and a coupon for products or services provided by the commercial advertiser.

11. A system for obtaining information regarding media content, comprising:
a media content receiving device;
a user interface via which a user specifies a portion of the media content about which the user seeks to obtain information;
a request transmitting device that automatically transmits a request to obtain information regarding the specified portion of the media content to an information providing entity;
an information receiving device that receives a directed communication from the information providing entity, the directed communication including information related to the specified portion of the media content and being directed to the user based on identification information provided by the user; and
an output/display device that at least one of outputs or displays contents of the directed communication to the user.

12. The system of claim 11, the media content receiving device being one of a radio or television.

13. The system of claim 11, the user interface being a single button for process activation located on at least one of the media content receiving device and the request transmitting device.

14. The system of claim 11, the request transmitting device supplementing the request to obtain information regarding the specified portion of the media content with the identification information provided by the user.

15. The system of claim 14, the information providing entity being a media content service provider that obtains the information related to the specified portion of the media content from multiple sources

16. The system of claim 15, the media content service provider addressing the directed communication to the user by matching the identification information provided by the user with stored or obtained contact or address information for the user.

17. The system of claim 11, the request transmitting device and the information receiving device being components of a single communicating device.

18. The system of claim 11, the media content comprising at least one of a commercial advertisement, a program, music, or a public service announcement.

19. The system of claim 11, the specified portion of the media content about which the user seeks to obtain information being an input from a commercial advertiser, and the information related to the specified portion of the media content being at least one of contact information for the commercial advertiser and a coupon for products or services provided by the commercial advertiser.

20. A non-transitory computer-readable medium storing instructions which, when executed by a processor, cause the processor to execute a method for obtaining information regarding media content, the method comprising:
receiving media content with a receiving device;
providing an input from a user, via a first communicating device, that specifies a portion of the media content about which the user seeks to obtain information;
receiving a directed communication addressed to the user in a second communicating device, the directed communication including information related to the specified portion of the media content; and
outputting contents of the directed communication from the second communicating device to the user,
the input from the user being provided by the user via a single actuation of a process activation device on a user interface for the first communicating device,
the first communicating device being one of an integral component of the receiving device and a separate communicating device from the receiving device in cooperative communication with the receiving device,
the input from the user being supplemented with user identification information and communicated via the processor in the first communicating device to a media content service provider, and
the media content service provider obtaining the information related to the specified portion of the media content from multiple sources and addressing the directed communication to the second communicating device using contact information provided by the user.
